(19) United States
(12) Patent Application Publication
(10) Pub. No.: US 2014/0145962 A1
(43) Pub. Date: May 29, 2014

(54) RECIPIENT-AWARE KEYBOARD LANGUAGE

(71) Applicant: Intel Corporation, Santa Clara, CA (US)

(72) Inventors: ARUN RADHAKRISHNAN, Zapopan (MX); MARIO BARBA GARCIA, Tlaquepaque (MX)

(73) Assignee: Intel Corporation, Santa Clara, CA (US)

(21) Appl. No.: 13/677,460

(22) Filed: Nov. 15, 2012

(51) Int. Cl. G06F 3/023

(52) U.S. Cl. CPC G06F 3/0237
USPC 345/171

(57) ABSTRACT

Disclosed are technologies that can automatically determine a keyboard language to be used when a user is communicating with a particular remote user, or recipient. Soft keyboard layout, automatic correction, predictive text and speech-to-text can be based on the determined keyboard language. A keyboard language for a particular recipient can be determined based on the recipient's geographical location, which could be stored in a user profile stored locally at the computing device or based on information received from the recipient during communication, such as the recipient computing device's IP address. B automatically determining a keyboard language to be used for a particular recipient, a user can be relieved of the overhead of having to repeatedly change the keyboard language setting when switching between communicating with recipients located in different countries or recipients with whom the user desires to communicate in different languages.

### BACKGROUND

Today's mobile computing devices allow users to communicate in variety of manners, such as via voice, voice combined with video, and messaging. One way mobile computing devices accept messages from a user when communicating via messaging is via a soft keyboard presented at a device touchscreen. Typically, the soft keyboard is configurable, and a user can change the keyboard language to enter messages in different languages. Changing the keyboard language can affect the soft keyboard layout as well as the language used for automatic correction and predictive text.

### BRIEF DESCRIPTION OF THE DRAWINGS

FIG. 1 is a diagram of an exemplary environment in which the technologies described herein can be utilized.

FIGS. 2 and 3 show illustrations of exemplary mobile computing devices in which a messaging user interface comprising a soft keyboard is presented at a mobile computing device touchscreen.

FIG. 4 is a block diagram of a first exemplary computing device in which technologies described herein may be implemented.

FIG. 5 is a flowchart of an exemplar method of communicating between a user using a computing device and a recipient using a recipient computing device.

FIG. 6 is a block diagram of a second exemplary computing device in which technologies described herein may be implemented.

FIG. 7 is a block diagram of an exemplary processor core that can execute instructions as part of implementing technologies described herein.

### DETAILED DESCRIPTION

Disclosed are technologies that can automatically determine the keyboard language to be used when a user is communicating with a particular remote user, or recipient. The keyboard language can be used to determine the layout of a soft keyboard presented on a computing device display, as well as the language used for automatic correction and predictive text. For example, if a smartphone user is messaging someone in Russia, the smartphone can determine the remote user's location and present a soft keyboard with Cyrillic characters on the smartphone display. A keyboard language for a particular remote user can be determined based on the recipient's geographical location. This information could be stored in a user profile stored locally at a user's computing device or based on information received from a recipient during communication, such as the recipient computing device's IP address. By automatically determining the keyboard language to be used for a particular recipient, a user can be relieved of having to repeatedly change the keyboard language when switching between communicating with recipients located in different countries or recipients with whom the user desires to communicate in different languages.

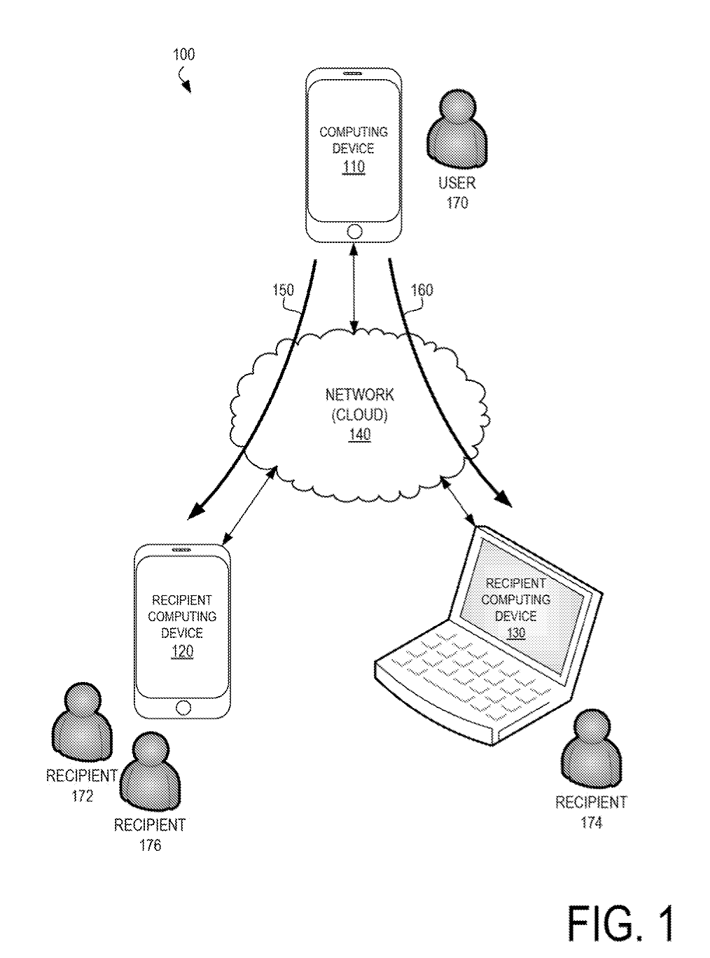

Reference is now made to the drawings, wherein like reference numerals are used to refer to like elements throughout. FIG. 1 is a diagram of an exemplary environment 100 in which the technologies described herein can be utilized. The environment 100 comprises a computing device 110 in communication with recipient computing devices 120 and 130 via a network or cloud 140. The computing devices 110, 120 and 130 can be any of the computing devices described herein, such as a mobile device (e.g., smartphone, laptop or tablet computer), desktop computer, server or any other computing device. The network 140 can be any network through which computing devices can communicate such as a Local Area Network (LAN), Wide Area Network (WAN) or the Internet.

Communication between computing device 110 and recipient computing devices 120 and 130 comprises messages 150 and 160 sent from computing device 110. Messages 150 and 160 can comprise email messages, Short Message Service (SMS) and Multimedia Messaging Service (MMS) messages and any other type of message that can be sent between two computing devices. These messages can comprise text messages. Text messages can comprise alphanumeric characters, symbols and numbers from any character set (e.g., English, Russian, Chinese, Arabic, Emoji). It is possible that a user 170 of the computing device 110 communicates with a recipient 172 of the recipient computing device 120 in a first language and with a recipient 174 of the recipient computing device 130 in as second language. The difference in languages used by the user 170 in communicating with the recipients 172 and 174 can be due to various reasons, such the recipients 172 and 176 being fluent only in different languages. It is also possible that the user 170 communicates with recipients 172 and 176, both users of recipient computing device 120, in different languages.

As used herein, the terms “in communication” and “communicating” refer to the sending of messages between users and include operations taken by a user or the user's computing device to establish a communication link between users. Thus, reference to a user being “in communication” or “communicating” with a recipient can include actions taken by the user or the user's computing device before a first message is sent to a recipient, such as the user selecting the recipient from a contact list or address book or the computing device accessing a user profile associated with the selected recipient.

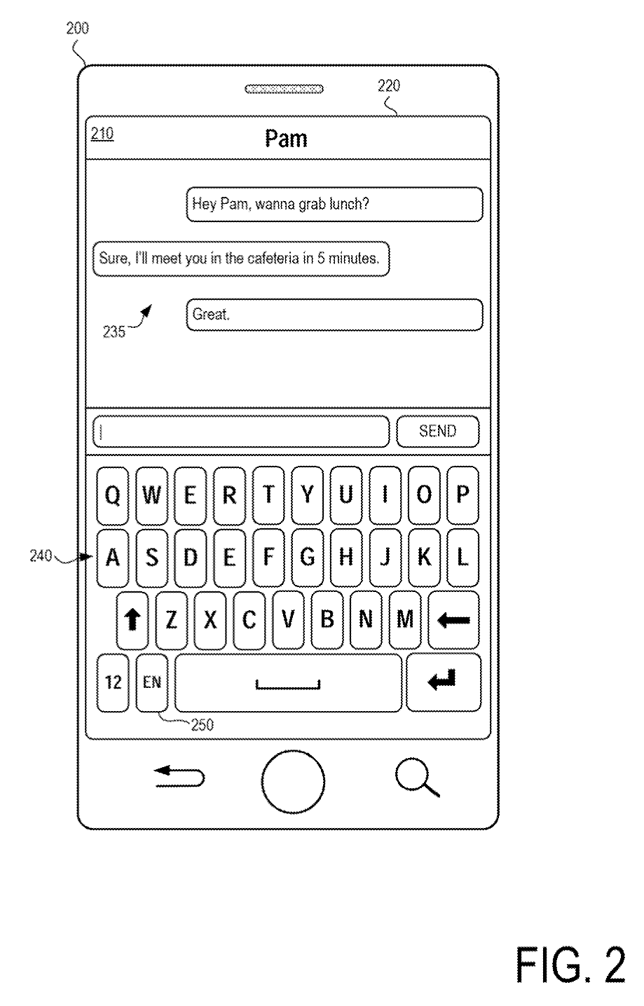

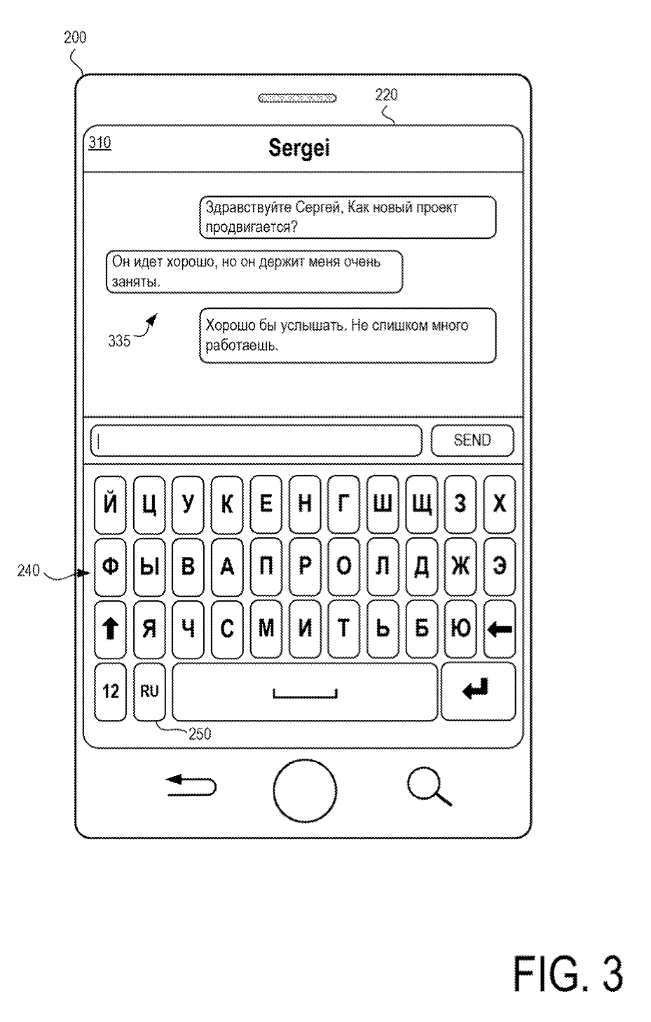

The computing device 110 comprises a configurable keyboard for receiving user input. In some embodiments, the configurable keyboard can be a soft keyboard (virtual keyboard, on-screen keyboard) presented at a touchscreen of the computing device 110, such as the soft keyboard 240 shown in FIGS. 2 and 3, discussed further below. Typically, the soft keyboard is controlled at the operating system level and is thus common across applications. However, in various embodiments, the soft keyboard can be controlled by an individual software application in other embodiments, the configurable keyboard can be a projection keyboard that determines user input based on detecting user interaction with a keyboard image projected onto a surface. By using a computing device incorporating technologies disclosed herein, a user can conveniently communicate with different recipients in different languages without having to manually change the keyboard layout when switching from communicating with one recipient to another.

FIG. 2 shows an illustration of as mobile computing device 200 in which a user interface 210 for a message application is presented at as touchscreen 220. The user interface 210 comprises a conversation 235 being conducted in English with a contact named “Pam,”and a soft keyboard 240 having an English language keyboard layout. The soft keyboard 240 comprises a language selection key 250 that allows a user to select a keyboard language or keyboard layout. For example, tapping the language selection key 250 can cause the soft keyboard 240 to change to a next keyboard language in a set of keyboard languages or cause a keyboard language menu to be presented from which a user can select a desired keyboard language. The soft keyboard 240 can comprise an indication of the keyboard language. For example, the language key 250 in FIG. 2 comprises the characters “EN” indicating that the keyboard language is English.

FIG. 3 shows an illustration of the mobile computing device 200 after a user has navigated from the conversation with Pam to a conversation with a contact named “Sergei.” The display 220 now comprises a user interface 310 comprising a conversation 335 being conducted in Russian. The keyboard language has been changed from English to Russian and the soft keyboard 240 is presented with a Russian language keyboard layout. The language selection key 250 comprises the characters “RU” to indicate that the keyboard language is Russian. Although the soft keyboard is shown in FIGS. 2 and 3 as being presented in the context of a messaging application, the soft keyboard can be presented in the context of an email or other message-based communication applications.

As can be seen in FIGS. 2 and 3, keyboard layouts can vary both in the number of keys and the characters displayed in the keyboard. Keyboard layouts can further vary in the number of keys presented and the alternative or hidden characters that they support. For example, a soft keyboard can present alternative characters for a character if the user touches a key for longer than a set amount of time. For instance, touching the “a” key can cause combinations of the characters “á â ã ä” to appear. Which alternative characters are presented for a given character in a soft keyboard, and the order in which these alternative characters are presented can vary depending on the keyboard language.

Typically, a soft keyboard layout is based on a keyboard language. Using the technologies disclosed herein, the keyboard language for a particular recipient with whom a user is communicating can be automatically determined. Thus, for example, when a user invokes a communication session or returns to a communication session with a particular recipient (e.g., by initiating a new messaging exchange with a recipient, or returning to an existing messaging exchange with a recipient), the user may not need to manually change the keyboard language or the layout of the soft keyboard. For example, if a user indicates that he wishes to send a text message to Sergei, the user may not need to manually select Russian as the keyboard language. The computing device can determine from a user profile for Sergei that Russian is the keyboard language for Sergei is Russian, and present the messaging user interlace 310 with a Russian keyboard layout.

This can be advantageous when a user is communicating with multiple recipients in different languages. For example, when a user switches from communicating with a first recipient in a first language to communicating with a second recipient in a second language, the user does not have to repeatedly change keyboard languages when switching between communication sessions. For example, referring back to FIGS. 2 and 3, a user switching back and forthbetween conversations with Pam and Sergei does not have to repeatedly switch the keyboard language between English and Russian.

The keyboard language to be used when communicating with a particular recipient can be determined in various manners. In some embodiments, the keyboard language can be determined based at least in part on a geographical location of a recipient or the recipient's computing device. The geographical location of a recipient computing device can be determined, for example, based on information received front the recipient computing device, such as the recipient computing device's IP address (which can be extracted from IP packet headers or IP packet payload), geographical coordinates of the recipient computing device and the like. recipient computing device can determine its location using various techniques and systems such as GPS, Wi-Fi positioning and cell tower triangulation. In other embodiments, the recipient computing device can send alternative or additional information indicating the recipient computing device's geographical location such as information about the recipient (e.g., residence address, home country, citizenship, languages the recipient is fluent in) and the like. This geographically identifying information can be supplied by a recipient computing device upon request or as part of information supplied as part of a communication protocol (e.g., the recipient computing device's IP address being supplied during in an email header or in the header of an IP packet, geographical coordinates of the recipient computing device supplied by the recipient computing device as part of a messaging protocol) or delivered in the payload of messages provided by the recipient computing device.

Alternatively, a user profile of a recipient or a device profile of a recipient computing device can comprise a recipient's or recipient computing device's geographical location. User and device profiles can be stored locally at a computing device or remotely, such as in the cloud. Thus, determining the geographical location of a recipient or a recipient computing device can comprise accessing a user or device profile. In other embodiments, the keyboard language to be used when communicating with a particular contact is expressly specified, such as in a user or device profile or in information received from a recipient computing device.

In still other embodiments, a computing device can deduce the keyboard language to use for a recipient, or the geographical location of a recipient or recipient device, based on information supplied by the recipient computing device. For example, a computing device can deduce the keyboard language by determining the language in which messages from the recipient device are sent. For instance, a computing device comprising language deduction logic can determine that messages supplied by a particular recipient computing device are in German, and set the keyboard language to a German for that recipient in response. A determined geographical location for a recipient or recipient computing device can be used to determine the keyboard language to be used when communicating with a particular contact. Any “logic” described herein can be implemented in hardware, software, firmware or any combination thereof.

In some embodiments, the keyboard language can be based on the country in which the recipient or recipient's computing device is located. For example, if the recipient computing device is in France, the keyboard language for that recipient can be set to French. Other algorithms, such as those that consider geographical subdivisions helms the country level can be used to determine the keyboard layout. For instance, if a recipient is determined to be located in Canada, the recipient's province or city can be considered for determining the keyboard language. For example, if a recipient is determined to be located in Quebec, the keyboard language can be set to French, otherwise the keyboard language can be set to English.

Various policies can be used to determine the keyboard language if a computing device has access to or receives multiple pieces of information that can be used to determine a keyboard language for a recipient. For example, in one policy, information about a recipient's location stored in a recipient user profile can take precedence over the recipient device's IP address. Such policies can reflect, for example, a user's preference to communicate in the same language with a recipient regardless of where the recipient is located.

In some embodiments, the keyboard language can be used as the language for other device features such as automatic correction and predictive text. For example, if the keyboard language for at recipient is set to German, the computing device can automatically correct words of a message being received at a soft keyboard according to the German language, and present predicted German text as the user enters a message.

In various embodiments, the keyboard language for a particular recipient can be used in translating voice input to text messages. For example, if the keyboard language for a particular recipient is French, the computing device can translate voice input supplied by the user to French messages. In other embodiments, the keyboard language can be determined based on a computing device determining the language used by a user when providing voice input to the computing device. For example, if a user is messaging with a first recipient in English (with the soft keyboard presented with an English keyboard layout), and the user then switches to messaging with a second recipient for whom the keyboard language is also English, if the user begins providing voice input in French for speech-to-text translation, the computing device can determine that the voice input is in French, and automatically set the keyboard language to French for the second recipient.

In some embodiments, after a computing device has determined a keyboard language for a particular recipient, the device can store the keyboard language for a recipient or a recipient computing device in a recipient user profile or a recipient computing device profile. A user can expressly specify the keyboard language to be used for a recipient of recipient computing device by manually setting the keyboard language in a user or device profile, thus allowing the user to communicate with a recipient in a language of the user's choosing.

In some embodiments, the keyboard language for a soft keyboard is determined by setting a keyboard language setting, which can be used by the device to determine one or more of the soft keyboard layout, the language to be used for automatic correction, the language to be used for predictive text and the language to be used for speech-to-text translation. The keyboard language setting can be automatically set by a computing device in response to determining that a user has initiated a communication session or switched to an existing communication session with a recipient for whom the associated keyboard language is different from the current keyboard language setting.

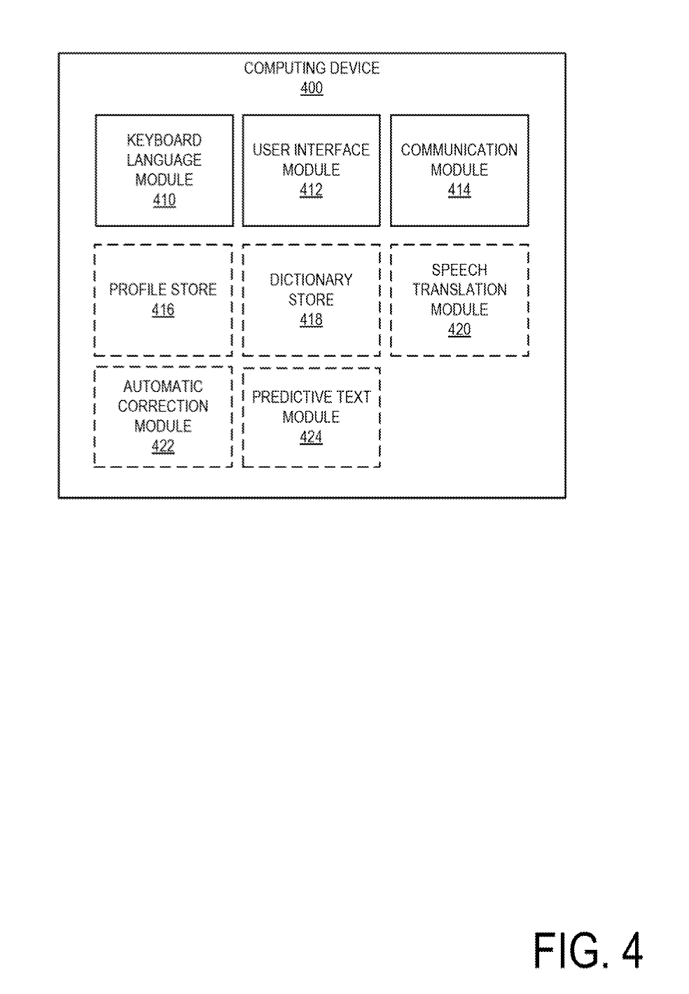

FIG. 4 is a block diagram of first exemplary computing device 400 in which technologies described herein may be implemented. The computing device 400 comprises as keyboard language module 410, a user interface module 412 and a communication module 414. The keyboard language module 410 can determine a keyboard language for a recipient with whom a user of the computing device 400 is in communication. The user interface module 412 can present a soil keyboard at a display of the computing device 400 with a layout based on the soft keyboard language and can receive messages via the soft keyboard. The communication module 414 can send messages to recipient computing devices.

In some embodiments, the computing device 400 can comprise additional modules (shown in FIG. 4 with dashed outlines), such as a profile store 416, dictionary store speech translation module 420, automatic correction module 422 and predictive text module 424. The profile store 416 can store user and device profiles for recipients and recipient computing devices and, in some embodiments, can comprise a contact list or address book. The dictionary store 418 can store one or more dictionaries to be used for automatic. correction or predictive text features. The speech translation module 420 can translate voice input into a text message using the keyboard language for a particular recipient. The automatic correction module 422 can automatically correct words of a message entered via a soft keyboard and the predictive text module 424 can present predicted text for a message being entered via a soft keyboard.

It is to be understood that FIG. 4 illustrates only one example of a set of modules that can be included in a computing device. In other embodiments, a computing device can have more or fewer modules than those shown in FIG. 4. For example, modules shown in FIG. 4 can be combined into a single module, or a single module shown in FIG. 4 can be split into multiple modules. The modules shown in FIG. 4 can be implemented in software, hardware, firmware or combinations thereof. Further, any of the modules shown in FIG. 4 can be part of the operating system of the computing device 400, one or more software applications independent of the operating system, or operate at another software layer.

A recipient computing device can comprise combinations of the modules shown in the computing device of FIG. 4. In some embodiments, a recipient computing device can comprise a communication module that can insert information into messages sent to another computing device that can be used to determine the geographical location of the recipient or recipient computing device, or a keyboard language to be used by a remote user when communicating with the recipient. In various embodiments, the recipient computing device can comprise a location determination module that can determine the location of the recipient computing device. The location module can comprise a GPS receiver and location determination logic that determines geographic coordinates of the recipient computing device based on GPS signals received by the GPS receiver. In various embodiments, the recipient's geographical location or keyboard language to be used can be expressly provided in information sent by the recipient computing device. This information can be included in, for example, IP packet headers or payloads. This information can be provided in messages used to establish a communication link with another device or in messages sent between two devices after a link has been established.

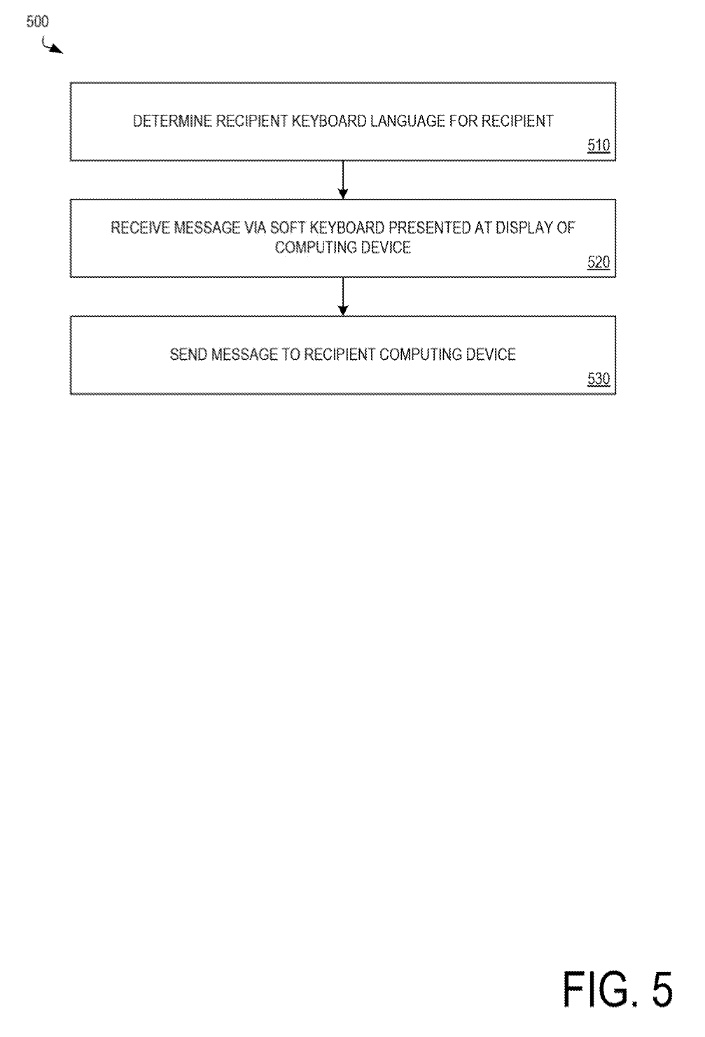

FIG. 5 is a flowchart of an exemplary method 500 of communicating between a user using a computing device and a recipient using a recipient computing device. The method 500 can be performed, for example, by a smartphone executing a messaging application in which Bob, the smartphone user, is conducting a conversation with Karsten, a user located in Germany and with whom Bob typically communicates in German. At process block 510, a recipient keyboard layout is determined for the recipient. In the example, Bob's smartphone determines that the keyboard language for Karsten is German, based on information stored in the smartphone's address book for Karsten. At process block 520, a message is received via a soft keyboard presented at a display of the computing device, the layout of the soil keyboard being based at least in part on the recipient keyboard language. In the example, Bob enters a message in German via the German soft keyboard. At process block 530, the message is sent to the recipient computing device. In the example, the German message received from Bob's smartphone is sent to Karsten's computing device.

The technologies, techniques and embodiments described herein can be performed by any of a variety of computing devices or systems, including mobile devices (such as smartphones, handheld computers, tablet computers, laptop computers, media players, cameras and video recorders), non-mobile devices (such as desktop computers, servers, gaming consoles, smart televisions) and embedded devices such as devices incorporated into a vehicle (such as a car or bicycle).

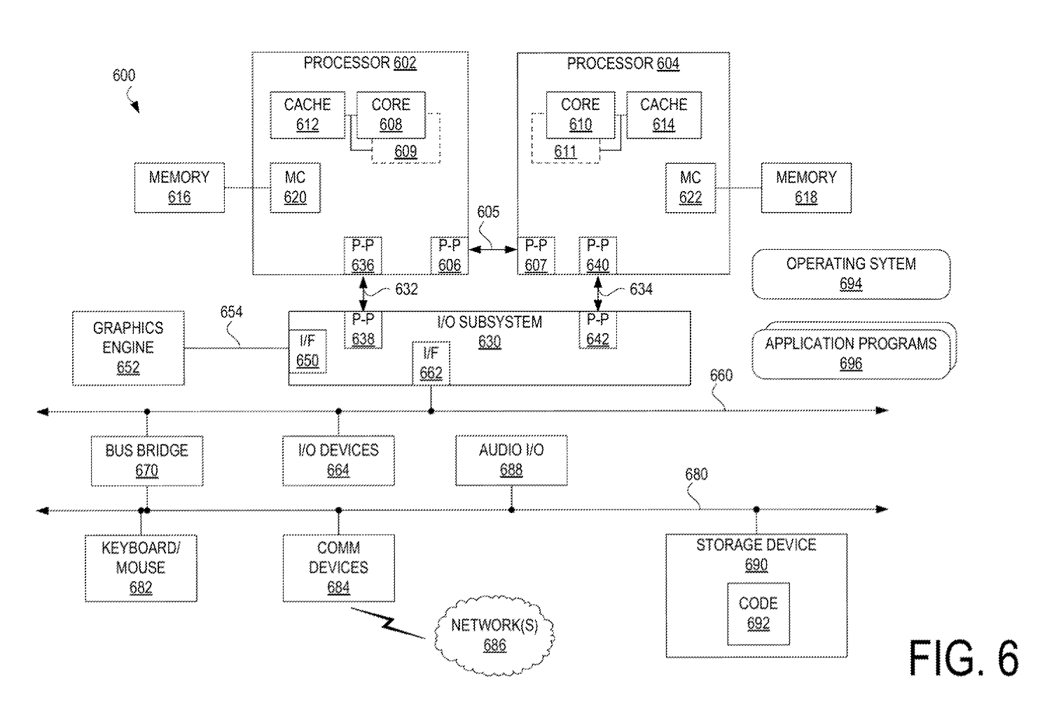

FIG. 6 is a block diagram of a second exemplary computing device in which technologies described herein may be implemented. Generally, components shown in FIG. 6 can communicate with other components, although not all connections are shown, for ease of illustration. The device 600 is a multiprocessor system comprising a first processor 602 and a second processor 604. The device 600 is illustrated as comprising point-to-point (P-P) interconnects. For example, a point-to-point (P-P) interface 606 of the processor 602 is coupled to a point-to-point interface 607 of the processor 604 via a point-to-point interconnection 605. It is to be understood that any or all of the point-to-point interconnects illustrated in FIG. 6 can be alternatively implemented as a multi-drop bus.

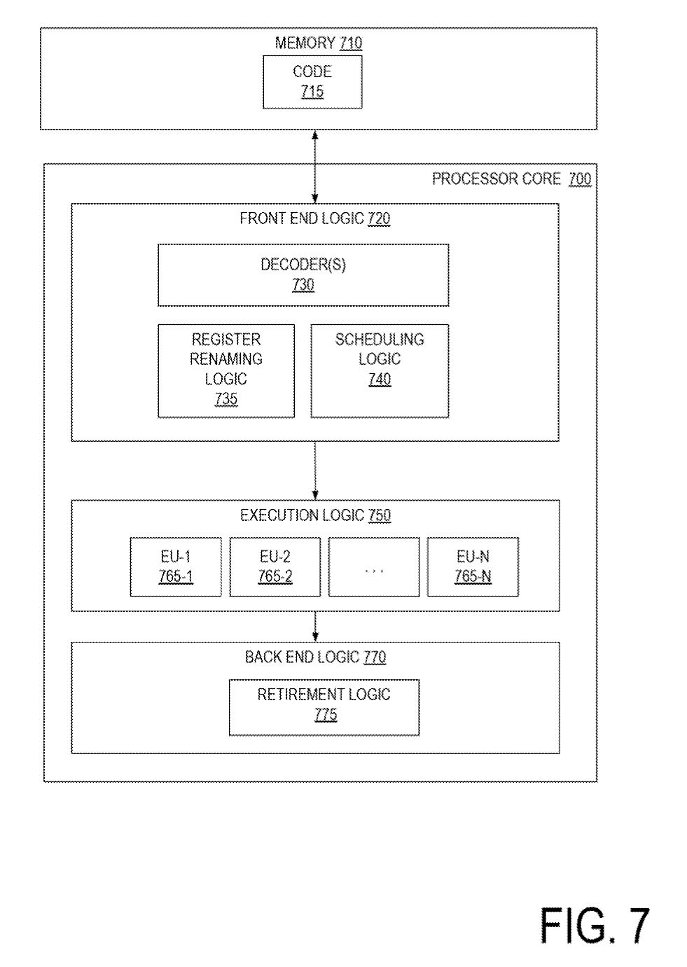

As shown in FIG. 6, the processors 602 and 604 are multicore processors. Processor 602 comprises processor cores 60 and 609, and processor 603 comprises processor cores 610 and 611. Processor cores 608-611 can execute computer-executable instructions in a manner similar to that discussed below in connection with FIG. 7, or in other manners.

Processors 602 and 604 further comprise one or more shared cache memory 612 and 614, respectively. The shared caches 612 and 614 can store data (e.g., instructions) utilized by one or more components of the processor, such as the processor cores 608-609 and 610-611. The shared caches 612 and 614 can be part of a memory hierarchy for the device 600. For example, the shared cache 612 can locally store data that is also stored in a memory 616 to allow fir faster access to the data by components of the processor 602. In some embodiments, the shared caches 612 and 614 can comprise multiple cache layers, such as combinations of level 1 (L1), level 2 (L2), level 3 (L3), level 4 (L4) and other cache layers. In other embodiments, the shared caches 612 and 614 can comprise multiple caches such as a last level cache (LLC).

Although the device 600 is shown with two processors, the device 600 can comprise one or more processors. Further, a processor can comprise one or more processor cores. A processor can take various forms such as a central processing unit, a controller, a graphics processor, an accelerator (such as a graphics accelerator or digital signal processor (DSP)) or a field programmable gate array (FPGA). The processors in a device can be the same or different as other processors. In some embodiments, the device 600 can comprise one or more processors that are heterogeneous or asymmetric to a first processor, accelerator, FPGA, or any other processor. There can be a variety of differences between the processing elements in a system in terms of a spectrum of metrics of merit including architectural, microarchitectural, thermal, power consumption characteristics and the like. These differences can effectively manifest themselves as asymmetry and heterogeneity amongst the processors in a system. In some embodiments, the processors 602 and 604 reside in the same die package.

Processors 602 and 604 further comprise memory controller logic (MC) 620 and 622. As shown in FIG. 6, MCs 620 and 622 control memories 616 and 618 are coupled to the processors 602 and 604, respectively. The memories 616 and 618 can comprise various types of memories, such as volatile memory (e.g., dynamic random access memories (DRAM) or static random access memory (SRAM)) or non-volatile memory (e.g., flash memory). While MCs 620 and 622 are illustrated as being integrated into the processors 620 and 604, in alternative embodiments, the MCs can be logic external to a processor, and can comprise one Or more layers of a memory hierarchy.

Processors 602 and 604 are coupled to an Input/Output (I/O) subsystem 630 via P-P interconnections 632 and 634. The point-to-point interconnection 632 connects a point-to-point interface 636 of the processor 602 with a point-to-point interface 638 of the 110 subsystem 630, and the point-to-point interconnection 634 connects a point-to-point interface 640 of the processor 604 with a point-to-point interface 642 of the subsystem 630. Input/Output subsystem 630 further includes an interface 650 to couple I/O subsystem 630 to a graphics engine 652, which can be a high-performance graphics engine. The I/O subsystem 630 and the graphics engine 652 are coupled via a bus 654. Alternately, the bus 644 could be a point-to-point interconnection.

Input/Output subsystem 630 is further coupled to a first bus 660 via an interface 662. The first bus 660 can be to Peripheral Component Interconnect (PCI) bus, a PCI Express bus, another third generation I/O interconnection bus, or any other bus type.

Various I/O devices 664 can be coupled to first bus 660, along with a bus bridge 670 that couples the first bus 660 to a second bus 680. In some embodiments, the second bus 680 can be a low pin count (LPC) bus. Various devices can be coupled to the second bus 680 including, for example, a keyboard/mouse 682, audio I/O devices 688 and a storage device 690, such as a hard disk drive, solid-state drive or other storage device for storing computer-executable instructions (code) 692. The code 692 comprises computer-executable instructions for performing technologies described herein. Components coupled to the second bus 680 further include communication device(s) 684, which can provide for communication between the device 600 and one or more wired or wireless networks 686 (e.g. Wi-Fi, cellular or satellite network) via one or more wired or wireless communication links (e.g., wire, cable, Ethernet connection, radio-frequency (RF) channel, infrared channel, WiFi channel) and using one or more communication standards (e.g., IEEE 802.11 standard and its supplements)

The device 600 can comprise removable memory such flash memory cards (e.g., SD (Secure Digital) cards), memory sticks, Subscriber Identity Module (SIM) cards). The memory in device 600 (including caches 612 and 614, memories 616 and 618 and storage device 690) can store data and computer-executable instructions for running an operating system 692 and application programs 694. Example data includes web pages, text messages, images, sound files, video data or other data sets that can he sent to or received from one or more network servers or other devices by the device 600 via one or more wired or wireless networks. The device 600 can also have access to external memory (not shown) such as external hard drives or cloud-based storage.

The device 600 thither comprises an operating system 694 that can control the allocation and usage of the components illustrated in FIG. 6 and support one or more application programs 696. The application programs 696 can include common mobile computing device applications (e.g., email applications, calendars, contact managers, web browsers, messaging applications) as well as other computing applications.

The device 600 can support various input devices, such as a touch screen (which can comprise a soft keyboard depending on the user interface presented), microphone, camera, physical keyboard, proximity sensor and trackball, and one or more output devices, such as a speaker and a display. Other possible input and output devices include piezoelectric and other haptic I/O devices. Any of the input or output devices can be internal to, external to, or removably attachable with the device 600. External input and output devices can communicate with the device 600 via wired or wireless connections.

In addition, the computing device 600 can provide one or more natural user interfaces (NUIs). For example, the operating system 692 or applications 694 can comprise speech recognition logic as part of a voice user interface that allows a user to operate the device 600 via voice commands. Further, the device 600 can comprise input devices and logic that allows a user to interact with the system 600 via a user's spatial or facial gestures. For example, a user's spatial gestures can be detected and interpreted to provide input to as gaining application.

The device 600 can thither comprise one or more wireless modems (which could comprise communication devices 684) coupled to one or more antennas to support communication between the system 600 and external devices. The wireless modems can support various wireless communication protocols and technologies such as Near Field Communication (NEC), Wi-Fi, Bluetooth, 4G Long Term Evolution (LTE), Code Division Multiplexing Access (CDMA), Universal Mobile Telecommunication System (UMTS) and Global System for Mobile Telecommunication (GSM). In addition, the wireless modems can support communication with one or more cellular networks for data and voice communications within a single cellular network, between cellular networks, or between the mobile computing device and a public switched telephone network (PSTN).

The device 600 can further include one or more input/output port (which can comprise, for example, a USB port, IEEE 1394 (FireWire) port, or RS-232 port) comprising physical connectors, a power supply, a satellite navigation system receiver such as a GPS (Global Positioning System) receiver, a gyroscope, an accelerometer and a compass. The GPS receiver can be coupled to a GPS antenna. The device 600 can further include additional antennas coupled additional receivers, transmitters or transceivers to enable additional functions.

It is to be understood that FIG. 6 illustrates only one exemplary device architecture. Devices can be based on alternative architectures to implement technologies described herein. For example, the elements of FIG. 6 can alternatively be partitioned using more or fewer integrated chips than shown in FIG. 6. For instance, a device can comprise a SoC (system-on-a-chip) integrated circuit incorporating multiple processors, a memory control, a graphics engine and additional components. Further, a device can connect elements via different bus configurations than that shown in FIG. 6. Moreover, the illustrated components in FIG. 6 are not required or all-inclusive, as shown components can be removed and other components added in alternative embodiments.

FIG. 7 is a block diagram of an exemplary processor core 700 that can execute computer-executable instructions to implementing technologies described herein. The processor core 700 can be a core for any type of processor, such as a microprocessor, an embedded processor, a digital signal processor (DSP), a network processor, or other device. The processor core 700 can be a single-threaded core or a multithreaded core in that it may include more than one hardware thread context (or “logical processor”) per core.

FIG. 7 also illustrates a memory 710 coupled to the processor 700. The memory 710 can be any of a wide variety of memories (including various layers of a memory hierarchy) described herein or other type of memory known to those of skill in the art. The memory 710 can store therein computer-executable instruction 715 (code) executable by the processor core 700.

The processor core comprises from end logic 720 that receives instructions from the memory 710. An instruction can be processed by one or more decoders 730. A decoder can generate as its output a micro operation such as a fixed width micro operation in a predefined format, or generate other instructions, microinstructions, or control signals, which reflect the original code instruction. The front-end logic 720 further comprises register renaming logic 735 and scheduling logic 740, which generally allocate resources and queues operations corresponding to converting an instruction for execution.

The processor core 700 further comprises execution logic 750, which comprises one or more execution units (EUs) 765-1 through 765-N. Some processor Core embodiments can include a number of execution units dedicated to specific functions or sets of functions. Other embodiments can include only one execution unit or one execution unit that can perform a particular function. The execution logic 750 performs the operations specified by code instructions. A tier completion of execution of the operations specified by the code instructions, back end logic 770 retires instructions using retirement logic 775. In some embodiments, the processor core 700 allows Out of order execution but requires in-order retirement of instructions. Retirement logic 770 can take a variety of forms as known to those of skill in the art (e.g., re-order buffers or the like).

In this manner, the processor core 700 is transformed during execution of instructions, at least in terms of the output generated by the decoder, hardware registers and tables utilized by the register renaming logic 735, and any registers (not shown) modified by the execution logic 750. Although not illustrated in FIG. 7, a processor can include other elements on an integrated chip with the processor core 700. For example, a processor may comprise one or more additional elements such as one or more of memory control logic, one or more graphics engines, I/O control logic and one or more caches.

Referring back to FIG. 1, the network or cloud 140 can provide various cloud-based services to computing devices implementing the technologies described herein. The environment 100 can utilize the cloud 140 in different ways to accomplish computing tasks. For example, some tasks (e.g., processing user input and presenting a user interface) can be performed on local computing devices (e.g., recipient computing devices 120 and 130) while other tasks (e.g., storage of user and device profiles) can be performed in the cloud 140.

Services can be provided by the cloud 140 through service providers, or through other providers of online services. Cloud-based services include, for example, email, SMS, MMS, social networking and website hosting. The cloud 140 can provide technologies and solutions described herein to connected devices 110, 120 and 130 using, at least in part, the service providers. For example, service providers can modify to message sent from a recipient computing device to include recipient computing device information that can be used to identify the device's geographical location.

The technologies described herein have at least the following advantages. By automatically determining a keyboard language it a particular recipient, a user can be relieved of having to manually specify the keyboard language when communicating with that recipient. This can be beneficial when a user is communicating with multiple recipients simultaneously in different language. In this case, when the user switches from communicating between recipients, the computing device automatically changes the keyboard language in response to the switch, and the soil keyboard layout changes automatically to reflect the keyboard language to be used with the current recipient.

Any of the disclosed methods can be implemented as computer-executable instructions or a computer program product. Such instructions can cause a computer to perform any of the disclosed methods. Generally, as used herein, the term “computer” refers to any computing device or system described or mentioned herein, or any other computing device. Thus, the term “computer-executable instruction” refers to instructions that can be executed by any computing device described or mentioned herein, or any other computing device.

The computer-executable instructions or computer program products as well as any data created and used during implementation of the disclosed technologies can be stored on one or more tangible computer-readable storage media, such as optical media discs (e.g., DVDs, CDs), volatile memory components (e.g., DRAM, SRAM), or non-volatile memory components (e.g., flash memory, disk drives). Computer-readable storage media can be contained in computer-readable storage devices such as solid-state drives, USB flash drives, and memory modules. Alternatively, the computer-executable instructions may be performed by specific hardware components that contain hardwired logic for performing all or a portion of disclosed methods, or by any combination of computer-readable storage media and hardware components. Such instructions can cause a computer to perform methods described herein.

The computer-executable instructions can be part of, for example, a dedicated software application or a software application that is accessed via a web browser or other software application (such as a remote computing application). Such software can be executed, for example, on a single computing device or in a network environment using one or more network computers. Further, it is to be understood that the disclosed technology is not limited to any specific computer language or program. For instance, the disclosed technologies can be implemented by software written in C++, Java, Perl, JavaScript, Adobe Flash, or any other suitable programming language. Likewise, the disclosed technologies are not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, and infrared communications), electronic communications, or other such communication means.

As used in this application and in the claims, a list of items connected by the word “or” and preceded by “one or more” or “one or more of” can mean any combination of the terms in the list. For example, the phrase “one or more of A, B or C” can mean A; B; C; A and B; A and C; B and C; or A, B and C.

The disclosed methods, apparatuses and systems should not be construed as limiting in any way. Instead, the present disclosure is directed toward all novel and nonobvious features and aspects of the various disclosed embodiments, alone and in various combinations and subcombinations with one another. The disclosed methods, apparatuses, and systems are not limited to any specific aspect or feature or combination thereof, nor do the disclosed embodiments require that any one or more specific advantages be present or problems be solved.

Theories of operation, scientific principles or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

The following examples pertain to further embodiments.

### EXAMPLE 1

An method of communicating between a user using a computing device and a recipient using a recipient computing device comprises determining a recipient keyboard language for the recipient; receiving a message via a soft keyboard presented at a display of the computing device, the layout of the soft keyboard being based at least in pan on the recipient keyboard language; and sending the message to the recipient computing device.

### EXAMPLE 2

The method of Example 1, further comprising, further comprising determining a recipient geographical location of the recipient or the recipient computing device, the keyboard language being determined at least in pan on the recipient geographical location.

### EXAMPLE 3

The method of Example 2, the recipient geographical location being determined at least in part on information received from the recipient computing device.

### EXAMPLE 4

The method of Example 3, wherein the information received from the recipient computing device comprises one or More of a recipient computing device IP address, an indication of the recipient keyboard language, or geographic coordinates of the recipient computing device.

### EXAMPLE 5

The method of Example 2, the recipient geographical location being determined at least in part on information in a user profile associated with the recipient or a device profile associated with the recipient computing device.

### EXAMPLE 6

The method of any one of the Examples 1-4, wherein the recipient is a first recipient and the recipient keyboard language is a first recipient keyboard language, the method further comprising: determining that the user is communicating with a second recipient; and presenting the soft keyboard at the display of the computing device with a layout based on a second recipient keyboard language, the second recipient keyboard language being different from the first recipient keyboard language.

### EXAMPLE 7

The method of Example 5, further comprising determining the second keyboard language, wherein the determining the second keyboard language is performed in response to determining that the user has switched from communicating with the first recipient to communicating with the second recipient.

### EXAMPLE 8

The method of Example 5, wherein the message is a first message, the method further comprising receiving a second message via the soft keyboard while the soft keyboard is presented with a layout based on the second recipient keyboard language, the receiving the first message comprising automatically correcting one or more word of the first message using the first keyboard language, and the receiving the second message comprising automatically correcting one or more word of the second text message using the second keyboard language.

### EXAMPLE 9

Any of the methods of Examples 5, wherein the message is a first message, the method further comprising receiving a second message via the soft keyboard while the soft keyboard is presented with a layout based on the second recipient keyboard language, the receiving the first message comprising presenting predictive text in the first keyboard language and the receiving the second message comprising presenting predictive text in the second keyboard language.

### EXAMPLE 10

An computing device, comprising: a keyboard language module to determine one or more recipient keyboard languages for one or more recipients and to Set a soft keyboard language setting to the recipient keyboard language associated with a recipient of the one or more recipients with whom a user of the computing device is in communication; and a user interlace module to present the soft keyboard at a display of the computing device with a layout based on the soft keyboard language setting and to receive messages via the soft keyboard.

### EXAMPLE 11

The computing device of Example 10, the keyboard language module further to determine a recipient geographical location of a recipient or a recipient computing device, the recipient keyboard language associated with the recipient being determined based at least in part on the recipient geographical location.

### EXAMPLE 12

The computing device of Example 10 or 11, the keyboard language module further to determine the recipient geographical location based at least in part on information received from the recipient computing device.

### EXAMPLE 13

The computing device of Example 12, wherein the information received from the recipient computing device comprises one or more of a recipient computing device IP address, an indication of the recipient keyboard language, or geographic coordinates of the recipient computing device.

### EXAMPLE 14

The computing device of Example 10 or 11, the keyboard language module further to determine the recipient geographical location of the based at least in part on information in a user profile associated with the recipient or a device profile associated with the recipient computing device.

### EXAMPLE 15

The computing device of Example 10 or 11, the keyboard language module further to receive an indication of a recipient keyboard language for a recipient from a recipient computing device.

### EXAMPLE 16

The computing device of Example 10 or 11, the user interface module further to receive voice input from the user at a microphone of the computing device; the computing device further comprising a speech translation module to translate the voice input into a speech-to-text message using the recipient keyboard language for the recipient with whom the user is communicating; the user interface module further to present the speech-to-text message in the user interface.

### EXAMPLE 17

The computing device of Example 16, the keyboard language module further to determine the recipient keyboard language for one of the one or more recipients based on determining a language used by a user when providing voice input to the computing device.

### EXAMPLE 18

The computing device of any one of the Examples 10 to 17, further comprising an automatic correction module to automatically correct at least a portion of messages entered via the soft keyboard using the recipient keyboard language associated with the recipient of the one or more recipients with whom the user of the computing is communicating.

### EXAMPLE 19

The computing device of any one of the Examples 10 to 18, further comprising a predictive text module to predict text for a message entered via the soft keyboard using the recipient keyboard language associated with the recipient of the one or more recipients with whom the user of the computing is communicating.

### EXAMPLE 20

The computing device of any of the Examples 10 to 19, the user interface module further to present the soft keyboard with a first keyboard layout associated with a first recipient keyboard language when the user is in communication with as first recipient and a second keyboard layout associated with a second recipient keyboard language when the user is in communication with a second recipient, the first keyboard layout being different from the second keyboard layout.

### EXAMPLE 21

One or more computer-readable storage media storing computer-executable instructions for causing a computing device to perform a method, the method comprising: determining as recipient keyboard language for the recipient; receiving a message via a soft keyboard presented at a display of the computing device, the layout of the soft keyboard being based at least in part on the recipient keyboard language; and sending the message to the recipient computing device.

### EXAMPLE 22

The one or more computer-readable storage media of Example 21, the method further comprising determining a recipient geographical location of the recipient or the recipient computing device, the keyboard language being determined at least in part on the recipient geographical location.

### EXAMPLE 23

The one or more computer-readable storage media of Example 22, the recipient geographical location being determined at least in part on information received from the recipient computing device.

### EXAMPLE 24

The one or more computer-readable storage media of Example 25, wherein the information received from the recipient computing device comprises one or more of a recipient computing device IP address, an indication of the recipient keyboard language, or geographic coordinates of the recipient computing device.

### EXAMPLE 25

The one or more computer-readable storage media of Example 19, the recipient geographical location being determined at least in part on information in a user profile associated with the recipient or a device profile associated with the recipient computing device.

### EXAMPLE 26

The one or more computer-readable storage media of Example 21, wherein the determining the keyboard language for the recipient comprises receiving an indication of the keyboard language from the recipient computing device.

### EXAMPLE 27

The one or more computer-readable storage media of Example 21, wherein the recipient is a first recipient and the recipient keyboard language is a first recipient keyboard language, the method further comprising: determining that the user is communicating with a second recipient; and presenting the soft keyboard at the display of the computing device with a layout based on a second recipient keyboard language, the second recipient keyboard language being different from the first recipient keyboard language.

### EXAMPLE 28

The one or more computer-readable storage media of Example 27, the method further comprising determining the second keyboard language.

### EXAMPLE 29

The one or more computer-readable storage media of Example 27 or 28, wherein the determining the second keyboard language is performed in response to determining that the user has switched from communicating with the first recipient to communicating with the second recipient.

### EXAMPLE 30

The one or more computer-readable storage media of Example 27 or 28, the second keyboard language being determined based at least in part on a geographical location of the second recipient or a second recipient computing device.

### EXAMPLE 31

The one or more computer-readable storage media of any one of the Examples 27 to 30, wherein the message is a first message, the method further comprising receiving a second message via the soft keyboard while the soft keyboard is presented with a layout based on the second recipient keyboard language, the receiving the first message comprising automatically correcting one or more word of the first message in accordance with the first keyboard language, and the receiving the second message comprising automatically correcting one or more word of the second text message in accordance with the second keyboard language.

### EXAMPLE 32

A computing device comprising: one of more processors: one or more computer-readable storage media having stored thereon computer-executable instructions causing the one or more processors to perform a method, the method comprising: determining a recipient keyboard language for the recipient: receiving a message via a soft keyboard presented at a display of the computing device, the layout of the soft keyboard being based at least in part on the recipient keyboard language; and sending the message to the recipient computing device.

### EXAMPLE 33

The computing device of Example 29, wherein the recipient is a first recipient and the recipient keyboard language is a first recipient keyboard language, the method further comprising: determining that the user is communicating with a second recipient; determining a second keyboard language for the second recipient, the second recipient keyboard language being different from the first recipient keyboard language; and presenting the soft keyboard at the display of the computing device with a layout based on the second recipient keyboard language; wherein the determining the second keyboard language is performed in response to determining that the user has switched from communicating with the first recipient to communicating with the second recipient.

### EXAMPLE 34

A computing device comprising one of more processors; one or more computer-readable storage media having stored thereon computer-executable instructions causing the one or more processors to perform any one of the methods of Examples 1 to 9.

### EXAMPLE 35

A computing device comprising means to perform any one of the methods of Examples 1 to 9.

We claim:

1. A method of communicating between a user using a computing device and a recipient using a recipient computing device, the method comprising:
determining a recipient keyboard language for the recipient;
receiving a message via a soft keyboard presented at a display of the computing device, the layout of the soft keyboard being based at least in part on the recipient keyboard language; and
sending the message to the recipient computing device.

2. The method of claim 1, further comprising determining a recipient geographical location of the recipient or the recipient computing device, the keyboard language being determined at least in part on the recipient geographical location.

3. The method of claim 2, the recipient geographical location being determined at least in part on information received from the recipient computing device.

4. The method of claim 2, the recipient geographical location being determined at least in part on information in a user profile associated with the recipient or a device profile associated with the recipient computing device.

5. The method of claim 1, wherein the recipient is a first recipient and the recipient keyboard language is a first recipient keyboard language, the method further comprising:
determining that the user is communicating with a second recipient; and
presenting the soft keyboard at the display of the computing device with a layout based on a second recipient keyboard language, the second recipient keyboard language being different from the first recipient keyboard language.

6. The method of claim 5, further comprising determining the second keyboard language, wherein the determining the second keyboard language is performed in response to determining that the user has switched from communicating with the first recipient to communicating with the second recipient

7. The method of claim 5, wherein the message is a first message, the method further comprising receiving a second message via the soft keyboard while the soft keyboard is presented with a layout based on the second recipient keyboard language, the receiving the first message comprising automatically correcting one or more word. of the first message using the first keyboard language, and the receiving the second message comprising automatically correcting one or more word of the second text message using the second keyboard language.

8. The method of claim 5, wherein the message is a first message, the method further comprising receiving a second message via the soft keyboard while the soft keyboard is presented with a layout based on the second recipient keyboard language, the receiving the first message comprising presenting predictive text in the first keyboard language and the receiving the second message comprising presenting predictive text in the second keyboard language.

9. A computing device, comprising:
a keyboard language module to determine one or more recipient keyboard languages for one or more recipients and to set a soft keyboard language setting to the recipient keyboard language associated with a recipient of the one or more recipients with whom a user of the computing device is in communication; and
a user interface module to present the soft keyboard at a display of the computing device with a layout based on the soft keyboard language setting and to receive messages via the soft keyboard.

10. The computing device of claim 9, the keyboard language module further to determine a recipient geographical location of a recipient or a recipient computing device, the recipient keyboard language associated with the recipient being determined based at least in part on the recipient geographical location.

11. The computing device of claim 10, the keyboard language module limber to determine the recipient geographical location based at least in pan on information received from the recipient computing device.

12. The computing device of claim 10, the keyboard language module further to determine the recipient geographical location of the based at least in pan on information in a user profile associated with the recipient or a device profile associated with the recipient computing device.

13. The computing device of claim 9, the keyboard language module further to receive an indication of a recipient keyboard language for a recipient from a recipient computing device.

14. The computing device of claim 9, the user interface module further to receive voice input from the user at a microphone of the computing device; the computing device further comprising a speech translation module to translate the voice input into a speech-to-text message using the recipient keyboard language for the recipient with whom the user is communicating; the user interface module further to present the speech-to-text message in the user interface.

15. The computing device of claim 9, the keyboard language module further to determine the recipient keyboard language for one of the one or more recipients based on determining a language used by a user when providing voice input to the computing device.

16. The computing device of claim 9, further comprising an automatic correction module to automatically correct at least a portion of messages entered via the soil keyboard using the recipient keyboard language associated with the recipient of the one or more recipients with whom the user of the computing is communicating.

17. The computing device of claim 9, further comprising a predictive text module to predict text for a message entered via the soft keyboard using the recipient keyboard language associated with the recipient of the one or more recipients with whom the user of the computing is communicating.

18. The computing device of claim 9, the user interface module further to present the soft keyboard with a first keyboard layout associated with a first recipient keyboard language when the user is in communication with a first recipient and a second keyboard layout associated with a second recipient keyboard language when the user is in communication with a second recipient, the first keyboard layout being different from the second keyboard layout.

19. One or more computer-readable storage media storing computer-executable instructions for causing a computing device to perform a method, the method comprising:
determining a recipient keyboard language for the recipient;
receiving a message via a soft keyboard presented at a display of the computing device, the layout of the soft keyboard being based at least in part on the recipient keyboard language; and
sending the message to the recipient computing device.

20. The one or more computer-readable storage media of claim 19, the method further comprising determining a recipient geographical location of the recipient or the recipient computing device, the keyboard language being determined at least in part on the recipient geographical location.

21. The one or more computer-readable storage media of claim 20, the recipient geographical location being determined at least in part on information received from the recipient computing device.

22. The one or more computer-readable storage media of claim 19, the recipient geographical location being determined at least in part on information in a user profile associated with the recipient or a device profile associated with the recipient computing device.

23. The one or more computer-readable storage media of claim 19, wherein the determining the keyboard language for the recipient comprises receiving an indication of the keyboard language from the recipient computing device.

24. The one or more computer-readable storage media of claim 19, wherein the recipient is a first recipient and the recipient keyboard language is a first recipient keyboard language, the method further comprising:
determining that the user is communicating with a second recipient; and
presenting the soft keyboard at the display of the computing device with a layout based on a second recipient keyboard language, the second recipient keyboard language being different from the first recipient keyboard language.

25. The one or more computer-readable storage media of claim 24, the method further comprising determining the second keyboard language.

26. The one or more computer-readable storage media of claim 24, wherein the determining the second keyboard language is performed in response to determining that the user has switched from communicating with the first recipient to communicating with the second recipient.

27. The one or more computer-readable storage media of claim 25 the second keyboard language being determined based at least in part on as geographical location of the second recipient or a second recipient computing device.

28. The one or more computer-readable storage media of claim 24, wherein the message is a first message, the method further comprising receiving a second message via the soft keyboard while the soft keyboard is presented with as layout based on the second recipient keyboard language, the receiving the first message comprising automatically correcting one or more word of the first message in accordance with the first keyboard language, and the receiving the second message comprising automatically correcting one or more word of the second text message in accordance with the second keyboard language.

29. A computing device comprising:
one of more processors;
one or more computer-readable storage media having stored thereon computer-executable instructions causing the one or more processors to perform a method, the method comprising:
determining a recipient keyboard language for the recipient;
receiving a message via a soft keyboard presented at a display of the computing device, the layout of the soft keyboard being based at least in part on the recipient keyboard language; and
sending the message to the recipient computing device.

30. The computing device of claim 29, wherein the recipient is a first recipient and the recipient keyboard language is a first recipient keyboard language, the method further comprising:
determining that the user is communicating with a second recipient;
determining a second keyboard language for the second recipient, the second recipient keyboard language being different from the first recipient keyboard language; and
presenting the soft keyboard at the display of the computing device with a layout based on the second recipient keyboard language;
wherein the determining the second keyboard language is performed in response to determining that the user has switched from communicating with the first recipient to communicating with the second recipient.
